(19) United States
(12) Patent Application Publication
(10) Pub. No.: US 2026/0260395 A1
(43) Pub. Date: Sep. 3, 2026

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: PANASONIC INTELLECTUAL PROPERTY MANAGEMENT CO., LTD., Osaka (JP)

(72) Inventor: Seikou ABE, Osaka (JP)

(73) Assignee: PANASONIC INTELLECTUAL PROPERTY MANAGEMENT CO., LTD., Osaka (JP)

(21) Appl. No.: 19/656,714

(22) Filed: Apr. 23, 2026

Related U.S. Application Data
(63) Continuation of application No. PCT/JP2024/038771, filed on Oct. 30, 2024.
(60) Provisional application No. 63/546,989, filed on Nov. 2, 2023.

(30) Foreign Application Priority Data
Jun. 18, 2024 (JP) 2024-097926

(51) Int. Cl. G06T 11/00; G06T 7/66; G06T 7/73; G06V 10/25; G06V 10/44

(52) U.S. Cl. CPC G06T 11/00; G06T 7/66; G06T 7/74; G06V 10/25; G06V 10/44; G06T 2200/21

(57) ABSTRACT

An information processing method includes: displaying a bird’s-eye view on a display of an information terminal; and displaying, in the bird’s-eye view, a plurality of photographing spot icons respectively indicating a plurality of photographing spots. The photographing spot icons are respectively associated with a plurality of images captured at the photographing spots. The images include a first image and a second image captured at a later time than the first image. The displaying of the photographing spot icons includes displaying, in the bird’s-eye view, a first photographing spot icon associated with the first image and a second photographing spot icon associated with the second image, the second image showing a change amount from the first image that has a predetermined value or higher.

### FIELD OF INVENTION

The present disclosure relates to a technology of displaying an image.

### BACKGROUND ART

For instance, Patent Literature 1 discloses a technology of a system configured to: designate a desired location shown in construction drawing data being displayed: give a photographing instruction to capture an image of a construction site serving as the designated desired location; and associate arrangement data related to the image of the construction site photographed on the basis of the photographing instruction with the designated desired location shown in the construction drawing data; and display and put the arrangement data on the construction drawing data.

Unfortunately, in the conventional technology, such a location to be photographed is determined in advance, and an image is captured only at the determined location. Therefore, the conventional technology fails to continuously capture a plurality of images, and has no consideration for a disadvantage of an increase in an image data amount.

Patent Literature 1: International Unexamined Patent Publication No. 2022/145021

### SUMMARY OF THE INVENTION

This disclosure has been accomplished to overcome the disadvantage described above, and has an object of providing a technology to achieve a reduction in an image data amount.

An information processing method according to an aspect of the present disclosure is an information processing method to be executed by a computer, and includes: displaying a bird’s-eye view on a display of an information terminal; and displaying, in the bird’s-eye view, a plurality of photographing spot icons respectively indicating a plurality of photographing spots. The photographing spot icons are respectively associated with a plurality of images captured at the photographing spots. The images include a first image and a second image captured at a later time than the first image. The displaying of the photographing spot icons includes displaying, in the bird’s-eye view, the first photographing spot icon associated with the first image and the second photographing spot icon associated with the second image, the second image showing a change amount from the first image that has a predetermined value or higher.

This disclosure achieves a reduction in an image data amount.

### BRIEF DESCRIPTION OF THE DRAWINGS

FIG. 1 is diagram showing an overall configuration of an information processing system in an embodiment.

FIG. 2 illustrates an example design drawing screen image in which a plurality of photographing spot icons is superimposed, before reduction in a plurality of images.

FIG. 3 illustrates an example design drawing screen image in which a plurality of photographing spot icons is superimposed, after the reduction in the images.

FIG. 4 is a flowchart showing an example process by a communication device in the embodiment.

FIG. 5 is a first flowchart showing an example of an image reduction process by a server in the embodiment.

FIG. 6 is a second flowchart showing an example of the image reduction process by the server in the embodiment.

FIG. 7 illustrates an example reference image, and an example comparative image obtained by turning a photographing direction of a photographing device to agree with a rightward direction in the embodiment.

FIG. 8 illustrates an example reference image, and an example comparative image obtained by making the photographing direction of the photographing device agree with an upward direction in the embodiment.

FIG. 9 illustrates an example reference image, and an example comparative image obtained by making the photographing direction of the photographing device agree with a downward direction in the embodiment.

FIG. 10 illustrates an example reference image, and an example comparative image obtained in advancement of the photographing device in the photographing direction in the embodiment.

FIG. 11 is a flowchart showing an example of an image displaying process by the server in the embodiment.

### DETAILED DESCRIPTION

Knowledge forming the basis of the present disclosure

A user interface has been developed to display, in a two-dimensional design drawing for a worksite or other site, a plurality of photographing spot icons respectively indicating photographing spots where the worksite is actually photographed, and to display an image captured at a certain photographing spot indicated by corresponding one photographing spot icon in response to selection of the one photographing spot icon. This configuration allows a manager of the worksite to grasp a situation of the worksite without visiting the worksite.

A photographing person moves on the worksite while photographing the worksite with a photographing device. The photographing device captures a plurality of images at a predetermined frame rate for a period from start of photographing to finish of the photographing. At this time, if the photographing person walks slowly or stops, a large amount of multiple similar images may be stored, and hence, an image data amount may increase.

In the conventional technology described above, a location to be photographed is determined in advance, and an image is captured only at the designated location. Therefore, the conventional technology fails to continuously capture a plurality of images, and has no consideration for a disadvantage of an increase in an image data amount.

The following technologies will be disclosed to overcome the disadvantage.

(1) An information processing method according to an aspect of the disclosure is an information processing method to be executed by a computer, and includes: displaying a bird’s-eye view on a display of an information terminal; and displaying, in the bird’s-eye view, a plurality of photographing spot icons respectively indicating a plurality of photographing spots. The photographing spot icons are respectively associated with a plurality of images captured at the photographing spots. The images include a first image and a second image captured at a later time than the first image. The displaying of the photographing spot icons includes displaying, in the bird’s-eye view, a first photographing spot icon associated with the first image and a second photographing spot icon associated with the second image, the second image showing a change amount from the first image that has a predetermined value or higher.

This configuration causes a memory to store the first image and the second image showing a change amount from the first image that has a predetermined value or higher, and thus enables deletion of an image located between the first image and the second image and achieves a reduction in an image data amount.

(2) In the information processing method according to (1) above, the displaying of the photographing spot icons may include displaying, in the bird’s-eye view, the first photographing spot icon associated with the first image and the second photographing spot icon associated with the second image, the second image showing that the change amount from the first image to the second image has a threshold or higher.

This configuration causes the memory to store the first image and the second image showing that the change amount has a threshold or higher, and thus enables deletion of an image located between the first image and the second image and achieves the reduction in the image data amount.

(3) The information processing method according to (2) above may further include: acquiring a reference image from among the images; acquiring a comparative image captured at a later time than the reference image from among the images; extracting a first feature point and a second feature point respectively from a first region and a second region resulting from horizontally dividing the reference image; extracting a third feature point and a fourth feature point respectively from a first region and a second region resulting from horizontally dividing the comparative image; calculating a first change amount from a position of the first feature point to a position of the third feature point; calculating a second change amount from a position of the second feature point to a position of the fourth feature point; and displaying the comparative image as the second image when at least one of the first change amount and the second change amount has the threshold or higher.

This configuration in which an image showing a larger change is stored and displayed achieves the reduction in the image data amount.

(4) The information processing method according to (3) above may further include avoiding displaying the comparative image when each of the first change amount and the second change amount does not have the threshold or higher.

This configuration in which an image captured at the same place and showing a smaller change is deleted without being displayed achieves the reduction in the image data amount.

(5) In the information processing method in (3) above, the acquiring of the reference image may include firstly acquiring, as the reference image, an image captured at a photographing start spot, and acquiring, when the comparative image remains as the second image, the remaining comparative image as the reference image.

This configuration allows comparative images for which at least one of the first change amount and the second change amount has the threshold or higher among the images to remain one after another, and enables the memory to store the remaining comparative images one after another.

(6) The information processing method according to any one of (3) to (5) may further include: calculating a first change direction from the position of the first feature point to the position of the third feature point; calculating a second change direction from the position of the second feature point to the position of the fourth feature point; and determining whether at least one of the first change amount and the second change amount has the threshold or higher when the first change direction and the second change direction agree with a leftward direction or the first change direction and the second change direction agree with a rightward direction.

For instance, when the photographing direction of the photographing device is changed to agree with the rightward direction, both the first change direction and the second change direction agree with the leftward direction. Alternatively, for example, when the photographing direction of the photographing device is changed to agree with the leftward direction, both the first change direction and the second change direction agree with the rightward direction. In this respect, when both the first change direction and the second change direction agree with one of the leftward direction and the rightward direction, the comparative image is determinable as an image acquired when the photographing direction of the photographing device is turned to agree with one of the rightward direction and the leftward direction. This configuration makes it possible to determine whether at least one of the first change amount and the second change amount has the threshold or higher.

(7) In the information processing method according to (6) above may further include deleting the comparative image when the first change direction and the second change direction agree with an upward direction or the first change direction and the second change direction agree with a downward direction.

For instance, when the photographing direction of the photographing device is made to agree with the downward direction, both the first change direction and the second change direction agree with the upward direction. Alternatively, for example, when the photographing direction of the photographing device is made to agree with the upward direction, both the first change direction and the second change direction agree with the downward direction. In this respect, when both the first change direction and the second change direction agree with one of the upward direction and the downward direction, the comparative image is determinable as an image acquired when the photographing direction of the photographing device agrees with one of the downward direction and the upward direction. This configuration makes it possible to delete the comparative image.

(8) The information processing method according to (6) or (7) may further include determining whether at least one of the first change amount and the second change amount has the threshold or higher when one of the first change direction and the second change direction agrees with the leftward direction and the other of the first change direction and the second change direction agrees with the rightward direction.

For instance, when the photographing device advances in the photographing direction, the first change direction agrees with the leftward direction and the second change direction agrees with the rightward direction. In this respect, when the first change direction agrees with the leftward direction and the second change direction agrees with the rightward direction, the comparative image is determinable as an image acquired in advancement of the photographing device in the photographing direction. This configuration makes it possible to determine whether at least one of the first change amount and the second change amount has the threshold or higher.

(9) In the information processing method according to any one of (6) to (8) above, the extracting of the first feature point and the second feature point may include recognizing a first feature object from the first region included in the reference image and extracting a gravity center of the recognized first feature object as the first feature point, and recognizing a second feature object from the second region included in the reference image and extracting a gravity center of the recognized second feature object as the second feature point, and the extracting of the third feature point and the fourth feature point may include recognizing a third feature object from the first region included in the comparative image and extracting a gravity center of the recognized third feature object as the third feature point, and recognizing a fourth feature object from the second region included in the comparative image and extracting a gravity center of the recognized fourth feature object as the fourth feature point.

This configuration includes recognizing the first feature object and the second feature object respectively from the first region and the second region included in the reference image, and recognizing the third feature object and the fourth feature object respectively from the first region and the second region included in the comparative image, and thereby enables extraction of the respective gravity centers of the recognized first feature object, the recognized second feature object, the recognized third feature object, and the recognized fourth feature object as the first feature point, the second feature point, the third feature point, and the fourth feature point.

Moreover, the disclosure can be realized as: the information processing method executing the above-described distinctive ways; and a information processing device including each distinctive feature corresponding to the distinctive ways executed by the information processing method. Additionally, the disclosure can be realized by a computer program causing a computer to execute the distinctive ways included in the information processing method. From these perspectives, the same advantageous effects as those of the information processing method are achievable in the following other aspects.

(10) An information processing device according to another aspect of the present disclosure includes a processor. The processor is configured to: display a bird’s-eye view on a display of an information terminal; and display, in the bird’s-eye view, a plurality of photographing spot icons respectively indicating a plurality of photographing spots. The photographing spot icons are respectively associated with a plurality of images captured at the photographing spots. The images include a first image and a second image captured at a later time than the first image. In the displaying of the photographing spot icons, a first photographing spot icon associated with the first image and a second photographing spot icon associated with the second image are displayed in the bird’s-eye view, the second image showing a change amount from the first image that has a predetermined value or higher.

(11) An information processing program according to still another aspect of the present disclosure includes: causing a computer to: display a bird’s-eye view on a display of an information terminal; and display, in the bird’s-eye view, a plurality of photographing spot icons respectively indicating a plurality of photographing spots. The photographing spot icons are respectively associated with a plurality of images captured at the photographing spots. The images include a first image and a second image captured at a later time than the first image. In the displaying of the photographing spot icons, a first photographing spot icon associated with the first image and a second photographing spot icon associated with the second image are displayed in the bird’s-eye view, the second image showing a change amount from the first image that has a predetermined value or higher.

(12) A non-transitory computer readable recording medium according to another aspect of the present disclosure stores an information processing program described in (11) above.

An embodiment of this disclosure will be described with reference to the accompanying drawings. The embodiment which will be described below represents a specific example of the disclosure. Numeric values, shapes, constituent elements, steps, and the order of the steps described below in the embodiment are mere examples, and thus should not be construed to delimit the disclosure. Moreover, constituent elements which are not recited in the independent claims each showing the broadest concept among the constituent elements in the embodiments are described as selectable constituent elements. The respective contents are combinable with each other in the embodiment.

### Embodiment

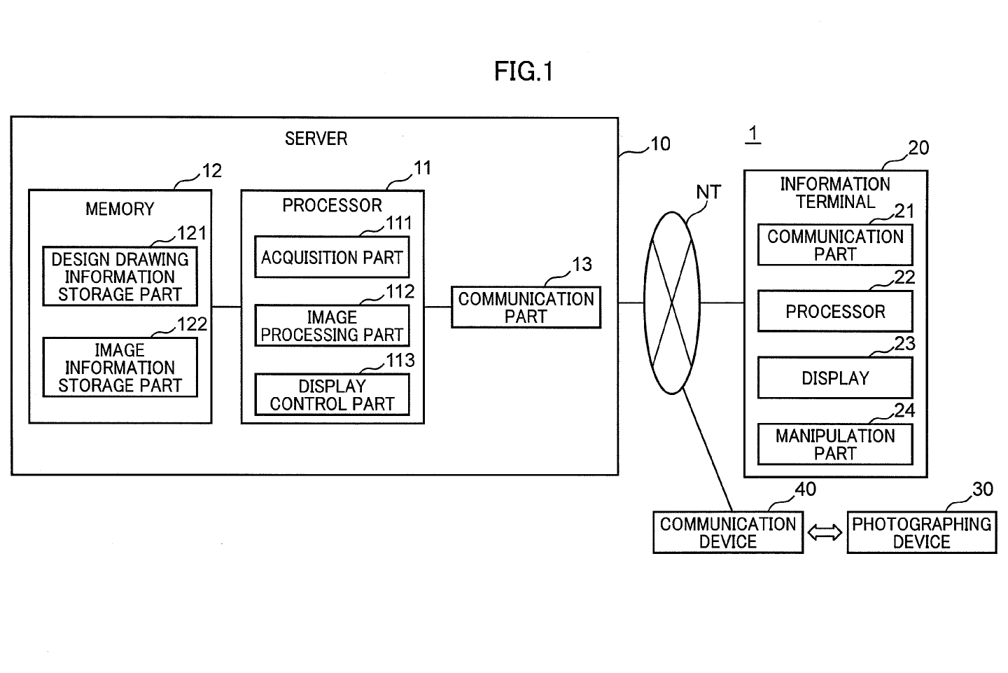

FIG. 1 is diagram showing an overall configuration of an information processing system 1 in an embodiment.

The information processing system 1 is configured to: display a bird’s-eye view for a workspace on a display 23 of an information terminal 20; and display, in the bird’s-eye view, a plurality of photographing spot icons respectively indicating a plurality of photographing spots. The information processing system 1 includes a server 10, the information terminal 20, a photographing device 30, and a communication device 40.

The server 10 is an example of an information processing device and a computer. The server 10, the information terminal 20, and the communication device 40 are communicably connected to one another via a network NT. The network NT includes, for example, the internet. The server 10 includes, for example, a cloud server including one or more computers. However, this is a mere example, and the server 10 may include an edge server, or may be mounted to the information terminal 20. A configuration in which the server 10 is mounted to the information terminal 20 corresponds to an example configuration of the information terminal 20 in the form of an information processing device.

The information terminal 20 is carriable by a user. The user is, for example, a manager of a predetermined space to be photographed by the photographing device 30. The predetermined space is, for example, a construction site. However, this is a mere example, and the predetermined space may be a worksite, a factory, a shop or store, or an office. The information terminal 20 may include a portable computer, e.g., a smartphone or a tablet computer, or may include a stationary computer. The information terminal 20 is configured to display an image on the display 23 under control by the server 10. Although FIG. 1 shows an example of one information terminal 20, a plurality of information terminals may be connected to the server 10 via the network NT. The information terminal 20 includes a communication part 21, a processor 22, the display 23, and a manipulation part 24.

The communication part 21 includes a communication interface that connects the information terminal 20 to the network NT. The communication part 21 is configured to send, to the server 10, instruction signals respectively indicating various instructions which the manipulation part 24 receives from the user. The communication part 21 is configured to receive, from the server 10, display data to display various display screen images.

The processor 22 includes, for example, a central processing unit (CPU), and causes the display 23 to display a display screen image indicated by the display data received by the communication part 21.

The display 23 includes, for example, various display devices, e.g., liquid crystal displays or organic Electro-Luminescence (EL) displays, to display various display screen images under control by the processor 22.

The manipulation part 24 includes, for example, a keyboard, a touch screen, and a mouse, and is configured to receive various instructions input by the user.

The communication device 40 includes a mobile information terminal, e.g., a smartphone or a tablet computer, and connects the photographing device 30 to the network NT. The communication device 40 and the photographing device 30 are communicably connected to each other via a near field communication channel, such as the Bluetooth (registered trademark).

The photographing device 30 includes, for example, an omnidirectional camera, and captures an image at a predetermined frame rate. The omnidirectional camera is also referred to as a 360-degree camera, and can acquire an omnidirectional image at 360 degrees. The photographing device 30 is, for example, a portable photographing device carriable by a photographing person. The photographing person is, for example, a worker or a site supervisor on a construction site. The photographing device 30 may execute photographing in a state of being held in a hand of the photographing person or in a state of being attached to a body (e.g., the head) of the photographing person. The photographing device 30 may include a typical camera.

The photographing person moves on the construction site while photographing the construction site with the photographing device 30. The photographing person presses, at a photographing start spot, a photographing button of the photographing device 30 while making a photographing direction of the photographing device 30 agree with the north direction to start photographing, and presses the photographing button again to finish the photographing when reaching a photographing finish spot. When the photographing is finished, the photographing device 30 sends a series of images having been captured to the communication device 40.

Each image includes a photographing date and time. For instance, the photographing date and time is acquired by a timepiece included in the photographing device 30. Here, the photographing device 30 is configured to capture an image at a predetermined frame rate (e.g., ten frames per second), and therefore, a photographing spot is defined by a frame periodic unit. However, this leads to a huge amount of data, and thus, the photographing spot may be defined for a predetermined time period (e.g., one second, five seconds, or ten seconds).

The communication device 40 is configured to receive the images sent from the photographing device 30. The communication device 40 is further configured to display a design drawing for the construction site, and receive designation by the photographing person about a position corresponding to the photographing start spot and a position corresponding to the photographing finish spot in the design drawing.

The photographing start spot and the photographing finish spot are specified in response to input of instruction from the photographing person to designate the position corresponding to each spot in a design drawing screen image of a site displayed on a display of the communication device 40. A two-dimensional coordinate axis is defined in the design drawing screen image. Thus, each of the photographing start spot and the photographing finish spot is defined by a two-dimensional coordinate value. The server 10 uses each of the photographing start spot and the photographing finish spot to specify a position corresponding to each photographing spot and a photographing direction for each image.

The communication device 40 sends, to the server 10 via the network NT, photographing information including the captured images. The photographing information is generated at every execution of one photographing operation. The one photographing operation means a series of actions from start of photographing to finish of the photographing by a worker carrying the photographing device 30 on the construction site. A plurality of images is captured through the one photographing operation. The photographing information includes the captured images and meta information about each of the images. The meta information includes a photographing ID, a photographing date and time, and a design drawing ID. The photographing ID is an identifier to identify a photographing operation. The photographing date and time represents a photographing date and time for each image. The design drawing ID is an identifier to identify a design drawing for a predetermined space corresponding to an image.

The server 10 includes a processor 11, a memory 12, and a communication part 13. The processor 11 includes, for example, a central processing unit (CPU). The processor 11 has an acquisition part 111, an image processing part 112, and an display control part 113. Each of the acquisition part 111, the image processing part 112, and the display control part 113 may come into effect, for example, when the processor 11 executes an information processing program, or may be established in the form of a dedicated hardware circuit, such as an application specific integrated circuit (ASIC). The information processing program may be recorded in a non-transitory computer-readable recording medium.

The communication part 13 includes a communication interface that connects the server 10 to the network NT. The communication part 13 is configured to receive the photographing information sent from the communication device 40. The communication part 13 is configured to receive, from the information terminal 20, instruction signals respectively indicating various instructions received from the user. The communication part 13 is configured to send, to the information terminal 20, display data to display various display screen images.

The memory 12 includes a non-volatile and rewritable storage device, such as a hard disk drive or a solid state drive. The memory 12 includes a design drawing information storage part 121 and an image information storage part 122.

The design drawing information storage part 121 stores design drawing information. The design drawing information includes image information indicating a design drawing for a predetermined space. The design drawing information is associated with a design drawing ID to identify the design drawing. The design drawing is an example of a bird’s-eye view. The design drawing represents a drawing of a design for a construction site, and may include a plan view, a blueprint, a map, or a perspective view of the construction site. The bird’s-eye view can be rephrased as an overhead view, that is, a view seen from above, or a view from a high position looking down.

The acquisition part 111 is configured to specify, by employing the Visual Simultaneous Localization and Mapping (SLAM) technique, a position corresponding to a photographing spot for each of the images from a photographing start spot, a photographing finish spot, and the images each included in the photographing information received by the communication part 13. Such a position corresponding to the photographing spot is expressed with a two-dimensional coordinate value in the design drawing. The acquisition part 111 further specifies a photographing direction for each of the images by employing the Visual SLAM technique. The photographing direction for each image is expressed with, for example, a three-dimensional polar coordinate vector.

The acquisition part 111 is configured to generate initial image information on the basis of the photographing information and the design drawing received by the communication part 13. The initial image information associates a plurality of images captured at a plurality of photographing spots to be subjected to reduction and meta information about each of the images with each other. The meta information includes a photographing ID, a photographing date and time, a photographing direction, a photographing spot, and a design drawing ID. The photographing direction represents a photographing direction in which the photographing device 30 has captured each image. The photographing spot represents positional information (a two-dimensional coordinate value) indicating the photographing spot for each image.

The image information storage part 122 stores image information. The image information associates a plurality of images captured at a plurality of photographing spots and resulting from the reduction, and meta information about each of the images with each other. The image information is generated at every receipt of the photographing information. The meta information includes a photographing ID, a photographing date and time, a photographing direction, a photographing spot, and a design drawing ID. The photographing direction represents a photographing direction in which the photographing device 30 has captured each image. The photographing spot represents positional information (a two-dimensional coordinate value) indicating the photographing spot for each image. The image information is generated by the image processing part 112 to be described later.

The communication part 13 is configured to receive an instruction to designate a photographing date and time from the information terminal 20. The manipulation part 24 of the information terminal 20 receives selection of the photographing date and time by the user, and the communication part 21 sends, to the server 10, an instruction to designate the photographing date and time selected by the user. The instruction to designate the photographing date and time contains a photographing ID.

The acquisition part 111 acquires, from the design drawing information storage part 121, a design drawing corresponding to the design drawing ID contained in the instruction to display the design drawing received by the communication part 13. Moreover, the acquisition part 111 acquires, from the image information storage part 122, a plurality of photographing spots each corresponding to the photographing ID contained in the instruction to designate the photographing date and time received by the communication part 13.

The image processing part 112 is configured to acquire a reference image from among the images included in the initial image information generated by the acquisition part 111. The image processing part 112 is configured to firstly acquire, as the reference image, an image captured at a photographing start spot. In a case where the image includes an omnidirectional image, the image processing part 112 acquires, as the reference image, an image falling within a predetermined range of the omnidirectional image in a photographing direction.

The image processing part 112 is configured to acquire a comparative image captured at a later time than the reference image from among the images included in the initial image information generated by the acquisition part 111. The image processing part 112 acquires, as the comparative image, an image at a subsequent frame to the reference image. In a case where the image includes an omnidirectional image, the image processing part 112 acquires, as the comparative image, an image falling within a predetermined range of the omnidirectional image in a photographing direction.

The image processing part 112 is configured to extract a first feature point and a second feature point respectively from a first region and a second region resulting from horizontally dividing the acquired reference image. Specifically, the image processing part 112 extracts the first feature point and the second feature point respectively from the first region and the second region resulting from horizontally dividing the reference image into the two regions. The image processing part 112 is configured to recognize a first feature object from the first region included in the reference image and extract a gravity center of the recognized first feature object as the first feature point. The image processing part 112 is further configured to recognize a second feature object from the second region included in the reference image and extract a gravity center of the recognized second feature object as the second feature point.

The image processing part 112 is configured to input the reference image into an image recognition model crated in advance through machine learning and acquire the first feature object in the first region and the second feature object in the second region, each of the first and second feature objects being output as a recognition result from the image recognition model. Each of the first feature object and the second feature object is surrounded by an outline defining a quadrangular shape. The outline surrounding the first feature object has a gravity center serving as the first feature point, and the outline surrounding the second feature object has a gravity center serving as the second feature point.

The image processing part 112 is configured to extract a third feature point and a fourth feature point respectively from a first region and a second region resulting from horizontally dividing the acquired comparative image. Specifically, the image processing part 112 extracts the third feature point and the fourth feature point respectively from the first region and the second region resulting from horizontally dividing the comparative image into the two regions. The image processing part 112 is configured to recognize a third feature object from the first region included in the comparative image and extract a gravity center of the recognized third feature object as the third feature point. The image processing part 112 is further configured to recognize a fourth feature object from the second region included in the comparative image and extract a gravity center of the recognized fourth feature object as the fourth feature point.

The image processing part 112 is configured to input the comparative image into an image recognition model crated in advance through machine learning and acquire the third feature object in the first region and the fourth feature object in the second region, each of the third and fourth feature objects being output as a recognition result from the image recognition model. Each of the third feature object and the fourth feature object is surrounded by an outline defining a quadrangular shape. The outline surrounding the third feature object has a gravity center serving as the third feature point, and the outline surrounding the fourth feature object has a gravity center serving as the fourth feature point.

The image processing part 112 is configured to calculate a first change direction from a position of the first feature point to a position of the third feature point. The image processing part 112 is configured to calculate a second change direction from a position of the second feature point to a position of the fourth feature point.

The image processing part 112 is configured to calculate a first change amount from the position of the first feature point to the position of the third feature point. The image processing part 112 is configured to calculate a second change amount from the position of the second feature point to the position of the fourth feature point.

The image processing part 112 is configured to determine whether at least one of the first change amount and the second change amount has a threshold or higher when the first change direction and the second change direction agree with a leftward direction or the first change direction and the second change direction agree with a rightward direction. For instance, when the photographing direction of the photographing device 30 is turned to agree with the rightward direction, both the first change direction and the second change direction agree with the leftward direction. Alternatively, for example, when the photographing direction of the photographing device 30 is turned to agree with the leftward direction, both the first change direction and the second change direction agree with the rightward direction. In this respect, when both the first change direction and the second change direction agree with one of the leftward direction and the rightward direction, the comparative image is determinable as an image acquired when the photographing direction of the photographing device 30 is turned to agree with one of the rightward direction and the leftward direction. In this case, the image processing part 112 determines whether at least one of the first change amount and the second change amount has the threshold or higher.

The image processing part 112 is further configured to delete the comparative image when the first change direction and the second change direction agree with an upward direction or the first change direction and the second change direction agree with a downward direction. For instance, when the photographing direction of the photographing device 30 is made to agree with the downward direction, both the first change direction and the second change direction agree with the upward direction. Alternatively, for example, when the photographing direction of the photographing device 30 is made to agree with the upward direction, both the first change direction and the second change direction agree with the downward direction. In this respect, when both the first change direction and the second change direction agree with one of the upward direction and the downward direction, the comparative image is determinable as an image acquired when the photographing direction of the photographing device 30 agrees with one of the downward direction and the upward direction. In this case, the image processing part 112 deletes the comparative image.

It is noted here that the image processing part 112 may determine whether at least one of the first change amount and the second change amount has the threshold or higher when both the first change direction and the second change direction agree with the upward direction or both the first change direction and the second change direction agree with the downward direction.

Moreover, the image processing part 112 is configured to determine whether at least one of the first change amount and the second change amount has the threshold or higher when one of the first change direction and the second change direction agrees with the leftward direction and the other of the first change direction and the second change direction agrees with the rightward direction. For instance, when the photographing device 30 advances in the photographing direction, the first change direction agrees with the leftward direction and the second change direction agrees with the rightward direction. In this respect, when the first change direction agrees with the leftward direction and the second change direction agrees with the rightward direction, the comparative image is determinable as an image acquired in advancement of the photographing device 30 in the photographing direction. In this case, the image processing part 112 determines whether at least one of the first change amount and the second change amount has the threshold or higher.

When at least one of the first change amount and the second change amount has the threshold or higher, the image processing part 112 may make the image information storage part 122 of the memory 12 store the comparative image as the second image. Alternatively, when each of the first change amount and the second change amount does not have the threshold or higher, the image processing part 112 deletes the comparative image. This results in reduction in the images captured by the photographing device 30.

The image processing part 112 may determine whether both the first change amount and the second change amount have the threshold or higher. The image processing part 112 may make the image information storage part 122 of the memory 12 store the comparative image as the second image when both the first change amount and the second change amount have the threshold or higher, and may delete the comparative image when both the first change amount and the second change amount do not have the threshold or higher. The image processing part 112 may determine whether the first change amount has the threshold or higher. The image processing part 112 may make the image information storage part 122 of the memory 12 store the comparative image as the second image when the first change amount has the threshold or higher, and may delete the comparative image when the first change amount does not have the threshold or higher. The image processing part 112 may determine whether the second change amount has the threshold or higher. The image processing part 112 may make the image information storage part 122 of the memory 12 store the comparative image as the second image when the second change amount has the threshold or higher, and may delete the comparative image when the second change amount does not have the threshold or higher.

When the comparative image is deleted, the image processing part 112 acquires, as a comparative image, an image at a subsequent flame to the deleted comparative image, calculates a first change amount and a second change amount, and determines whether to make the memory 12 store the acquired comparative image on the basis of the calculated first change amount and the calculated second change amount. The image processing part 112 is further configured to acquire, when the comparative image remains as the second image, that is, when the comparative image is stored in the memory 12, the remaining comparative image as the reference image. The image processing part 112 then acquires an image at a subsequent fame to the acquired reference image as a comparative image, calculates a first change amount and a second change amount, and determines whether to make the memory 12 store the acquired comparative image on the basis of the calculated first change amount and the calculated second change amount. The image processing part 112 repeats the operation from acquisition of a reference image to storage or deletion of a comparative image, until an image captured at a certain photographing finish spot is acquired as the comparative image and it is finally determined whether to make the memory 12 store the comparative image.

The display control part 113 is configured to cause the display 23 of the information terminal 20 to display a design drawing for a workspace. The display control part 113 causes the display 23 of the information terminal 20 to display the design drawing acquired by the acquisition part 111. The display control part 113 is configured to send display data for the design drawing to the information terminal 20 via the communication part 13. The communication part 21 of the information terminal 20 receives the display data sent from the server 10. The display 23 displays the design drawing received by the communication part 21.

The display control part 113 is configured to display, in the design drawing, a plurality of photographing spot icons respectively indicating a plurality of photographing spots. The photographing spot icons are respectively associated with a plurality of images captured at the photographing spots. The images include a first image and a second image captured at a later time than the first image. The display control part 113 is configured to display, in the design drawing, a first photographing spot icon associated with the first image and a second photographing spot icon associated with the second image, the second image showing a change amount from the first image that has a predetermined value or higher. The display control part 113 is configured to display, in the design drawing, the first photographing spot icon associated with the first image and the second photographing spot icon associated with the second image, the second image showing that the change amount from the first image to the second image has a threshold or higher.

The display control part 113 is configured to display the comparative image as the second image when at least one of the first change amount and the second change amount has the threshold or higher. The display control part 113 is further configured to avoid displaying the comparative image when each of the first change amount and the second change amount does not have the threshold or higher.

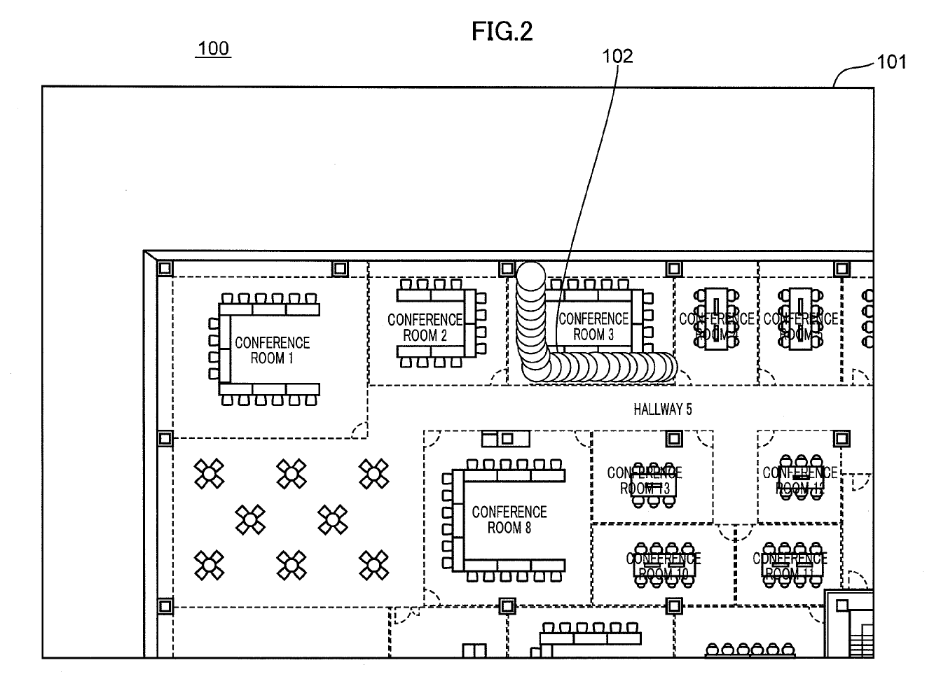

FIG. 2 illustrates an example design drawing screen image 100 in which a plurality of photographing spot icons 102 is superimposed, before reduction in a plurality of images. The design drawing screen image 100 shows a design drawing 101 for a workspace. In the design drawing screen image 100, the photographing spot icons 102 are superimposed and displayed.

Each photographing spot icon 102 indicates a photographing spot. The photographing spot icon 102 is associated with an image captured at a corresponding photographing spot. In this example, the photographing spot icon 102 includes an image having a circular shape. The photographing spot icons 102 displayed here respectively correspond to a plurality of photographing spots belonging to one certain photographing operation. A route from the photographing spot icon at one end (the photographing spot icon located at a lower right position in FIG. 2) to the photographing spot icon at another end (the photographing spot icon located at an upper left position in FIG. 2) shows a trace followed by the photographing person in the photographing operation.

The photographing device 30 captures an image at a predetermined frame rate. In this configuration, the number of images is expressed with “frame rate (fps) * photographing time (sec.)”. FIG. 2 shows no reduction in the images and thus no change in the number of photographing spot icons 102. Accordingly, the photographing spot icons 102 are displayed in an overlapping manner along the trace followed by the photographing person.

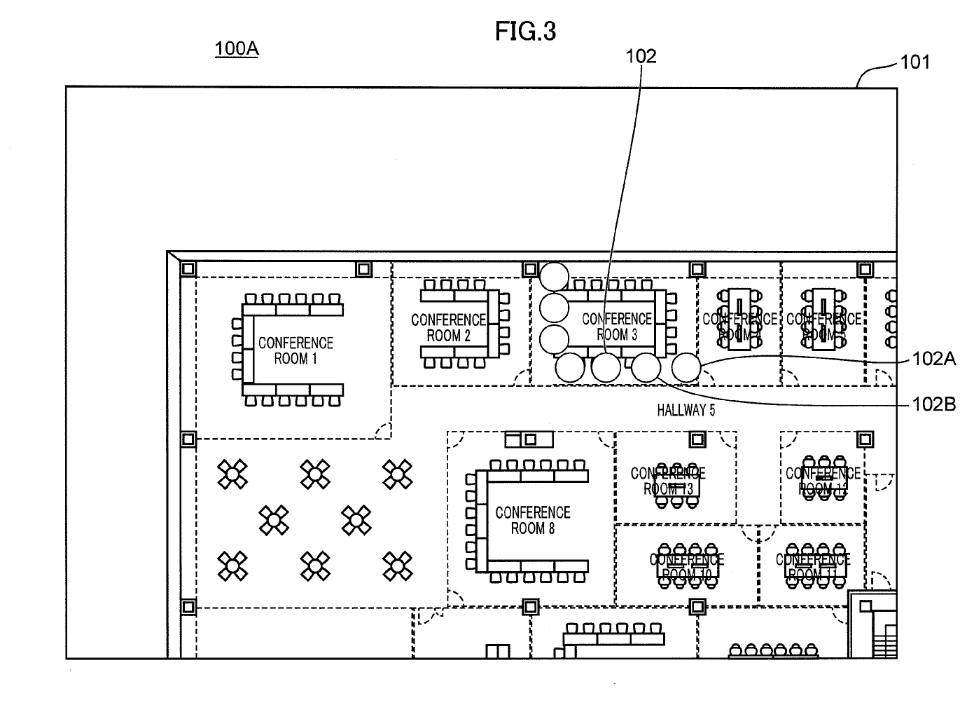

FIG. 3 illustrates an example design drawing screen image 100A in which a plurality of photographing spot icons 102 is superimposed, after the reduction in the images. The design drawing screen image 100A shows the design drawing 101 for the workspace. The design drawing screen image 100A shows the design drawing 101 in which a first photographing spot icon 102A associated with a first image and a second photographing spot icon 102B associated with a second image are superimposed, the second image showing that a change amount from the first image to the second image has a threshold or higher. An interval between photographing spot icons 102 illustrated in FIG. 3 is greater than an interval between the photographing spot icons 102 illustrated in FIG. 2. This is because of the reduction in the images captured by the photographing device 30.

Each photographing spot icon 102 includes an image having a circular shape. The shape of the photographing spot icon 102 is a mere example, and may be another shape. The photographing spot icon 102 is associated with an image captured at a corresponding photographing spot. The manipulation part 24 may receive selection of one photographing spot icon 102 by the user from among the photographing spot icons 102. When the one photographing spot icon 102 is selected from among the photographing spot icons 102, the display control part 113 reads out, from the image information storage part 122, an image corresponding to the selected one photographing spot icon 102, and causes the display 23 to display the read out image.

Here, a process by the communication device 40 in the embodiment will be described.

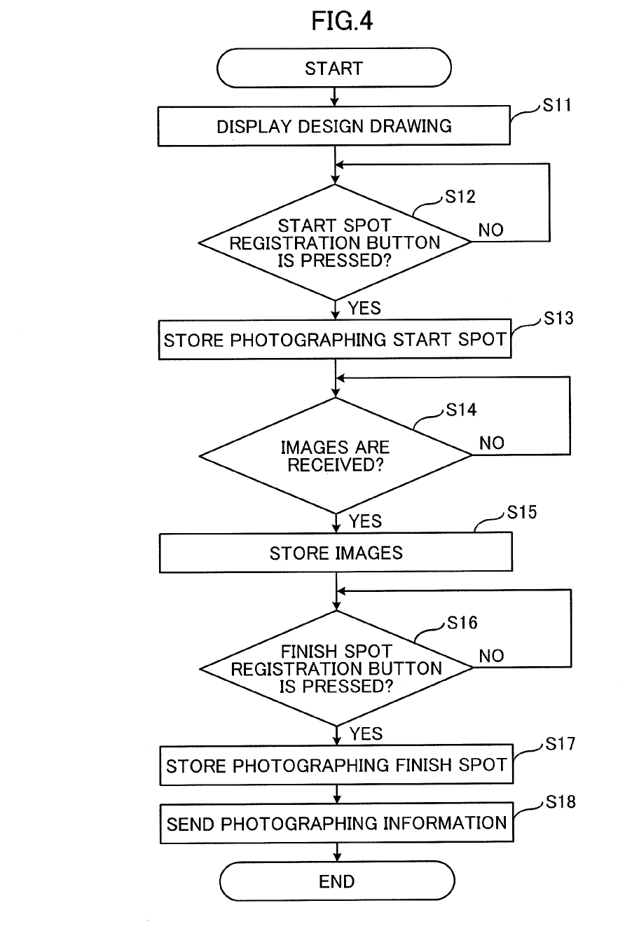

FIG. 4 is a flowchart showing an example of the process by the communication device 40 in the embodiment.

First, in step S11, the communication device 40 displays a design drawing selected by a photographing person. At this time, the communication device 40 receives the selection of the design drawing by the photographing person.

Subsequently, in step S12, the communication device 40 determines whether a start spot registration button is pressed. At this time, the communication device 40 displays the start spot registration button together with the design drawing. The communication device 40 receives input of a start spot position in the design drawing by the photographing person, and receives pressing of the start spot registration button by the photographing person. For instance, the photographing person touches the start spot position in the design drawing being displayed. In this way, the start spot position is input. Then, the photographing person presses the start spot registration button.

The photographing person presses the photographing button of the photographing device 30, after pressing the start spot registration button, to start photographing for an image with the photographing device 30.

When it is determined that the start spot registration button is not pressed (NO in step S12), step S12 is repeated.

In contrast, when it is determined that the start spot registration button is pressed (YES in step S12), the communication device 40 stores, in step S13, a photographing start spot shown in the design drawing. The communication device 40 stores a coordinate of the photographing start spot shown in the design drawing.

Next, in step S14, the communication device 40 determines whether a plurality of images is received from the photographing device 30. The photographing person presses the photographing button of the photographing device 30 again to finish the photographing when reaching a photographing finish spot. When the photographing button is pressed, the photographing device 30 sends the captured images to the communication device 40.

When it is determined that a plurality of images is not received from the photographing device 30 (NO in step S14), step S14 is repeated.

In contrast, when it is determined that a plurality of images is received from the photographing device 30 (YES in step S14), the communication device 40 stores, in step S15, the received images.

Subsequently, in step S16, the communication device 40 determines whether a finish spot registration button is pressed. At this time, the communication device 40 displays the finish spot registration button together with the design drawing. The communication device 40 receives input of a finish spot position in the design drawing by the photographing person, and receives pressing of the finish spot registration button by the photographing person. For instance, the photographing person touches the finish spot position in the design drawing being displayed. In this way, the finish spot position is input. Then, the photographing person presses the finish spot registration button.

When it is determined that the finish spot registration button is not pressed (NO in step S16), step S16 is repeated.

In contrast, when it is determined that the finish spot registration button is pressed (YES in step S16), the communication device 40 stores, in step S17, a photographing finish spot shown in the design drawing. The communication device 40 stores a coordinate of the photographing finish spot shown in the design drawing.

Then, in step S18, the communication device 40 sends photographing information including the images to the server 10.

Next, an image reduction process by the server 10 in the embodiment will be described.

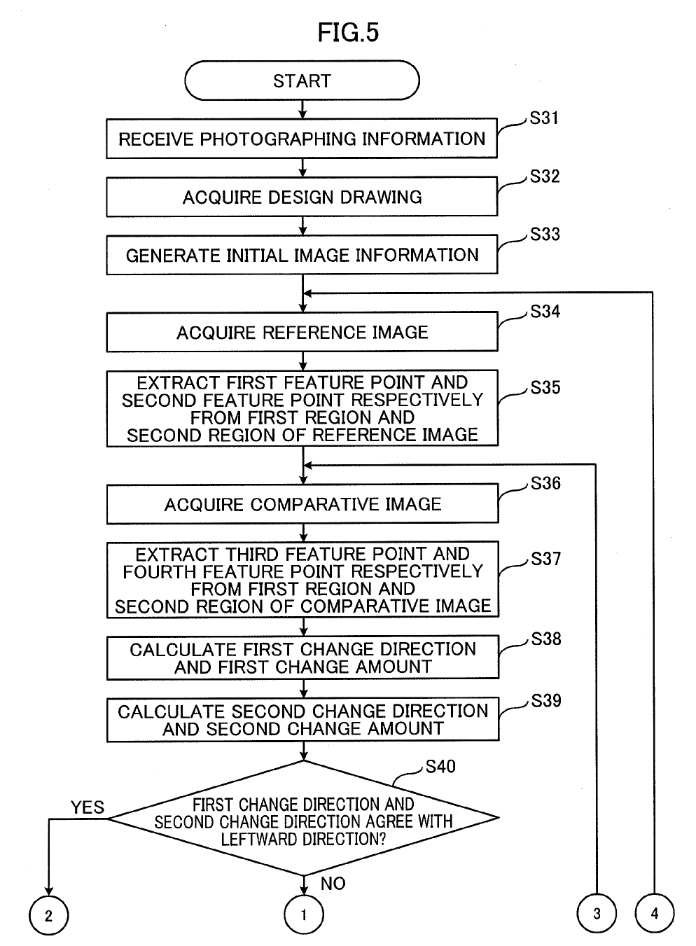

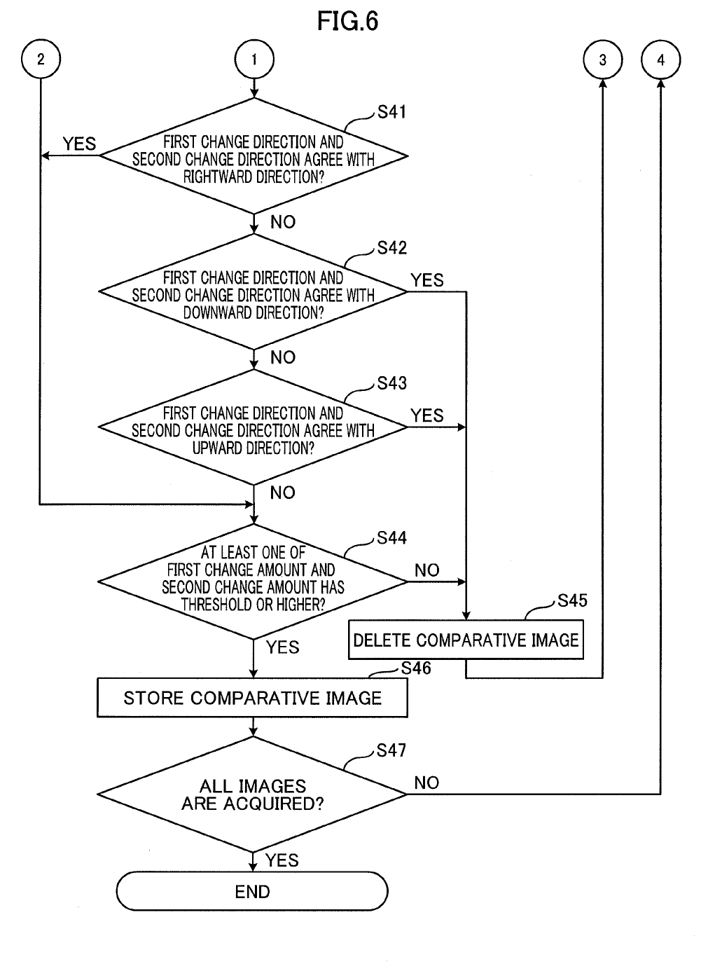

FIG. 5 is a first flowchart showing an example of the image reduction process by the server 10 in the embodiment. FIG. 6 is a second flowchart showing an example of the image reduction process by the server 10 in the embodiment.

First, in step S31, the communication part 13 receives the photographing information sent from the communication device 40.

Subsequently, in step S32, the acquisition part 111 acquires a design drawing from the design drawing information storage part 121. The acquisition part 111 reads out, from the design drawing information storage part 121, such a design drawing corresponding to a design drawing ID included in the photographing information received by the communication part 13.

Then, in step S33, the acquisition part 111 generates initial image information on the basis of the photographing information and the design drawing. The acquisition part 111 calculates a photographing spot and a photographing direction shown in the design drawing for each of the images by employing the Visual SLAM technique. The initial image information associates the images captured by the photographing device 30 to be subjected to reduction and meta information about each of the images with each other. The meta information includes a photographing ID, a photographing date and time, a photographing direction, a photographing spot, and a design drawing ID.

Next, in step S34, the image processing part 112 acquires a reference image from among the images included in the initial image information generated by the acquisition part 111. Here, the image processing part 112 acquires, as the reference image, an image captured at a photographing start spot.

Subsequently, in step S35, the image processing part 112 extracts a first feature point and a second feature point respectively from a first region and a second region of the acquired reference image. The first region is a left region of two regions resulting from dividing the reference image by a perpendicular bisector. The second region is a right region of the two regions resulting from dividing the reference image by the perpendicular bisector. For example, each of the first feature point and the second feature point is expressed with a coordinate in an orthogonal coordinate system having an origin in a pixel at a lower left position in the reference image.

Then, in step S36, the image processing part 112 acquires a comparative image captured at a later time than the reference image from among the images included in the initial image information generated by the acquisition part 111. The image processing part 112 acquires, as the comparative image, an image at a subsequent frame to the reference image.

Next, in step S37, the image processing part 112 extracts a third feature point and a fourth feature point respectively from a first region and a second region of the acquired comparative image. The first region is a left region of two regions resulting from dividing the comparative image by a perpendicular bisector. The second region is a right region of the two regions resulting from dividing the comparative image by the perpendicular bisector. For example, each of the third feature point and the fourth feature point is expressed with a coordinate in an orthogonal coordinate system having an origin in a pixel at a lower left position in the comparative image.

Subsequently, in step S38, the image processing part 112 calculates a first change direction and a first change amount from a position of the first feature point to a position of the third feature point. Each of the first change direction and the first change amount is expressed by a first vector having a start point on a coordinate of the first feature point and a finish point on a coordinate of the third feature point. A direction of the first vector serves as the first change direction, and a magnitude of the first vector serves as the first change amount.

Then, in step S39, the image processing part 112 calculates a second change direction and a second change amount from a position of the second feature point to a position of the fourth feature point. Each of the second change direction and the second change amount is expressed by a second vector having a start point on a coordinate of the second feature point and a finish point on a coordinate of the fourth feature point. A direction of the second vector serves as the second change direction, and a magnitude of the second vector serves as the second change amount.

Next, in step S40, the image processing part 112 determines whether both the first change direction and the second change direction agree with the leftward direction.

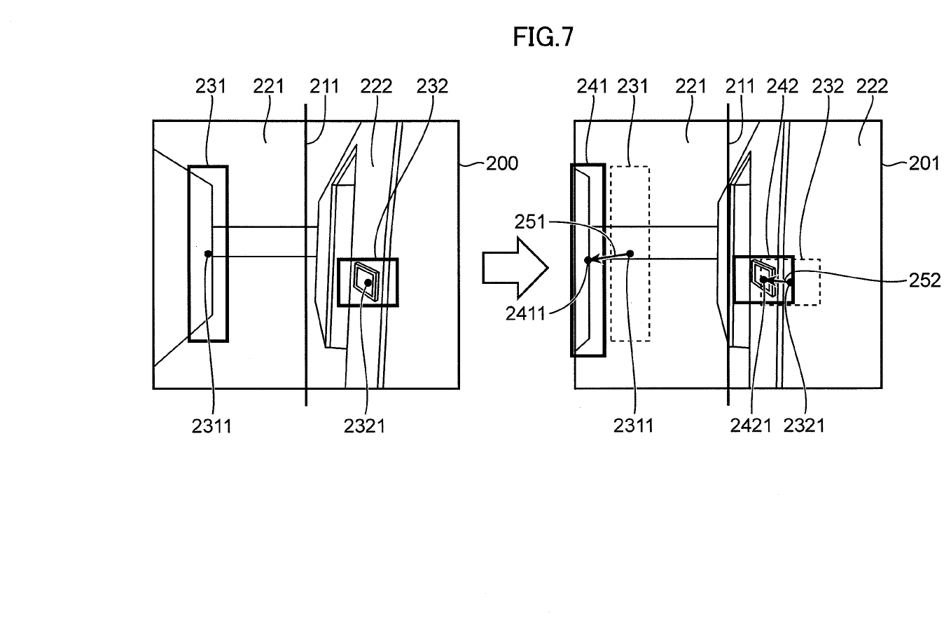

FIG. 7 illustrates an example reference image, and an example comparative image obtained by turning a photographing direction of the photographing device 30 to agree with the rightward direction in the embodiment.

FIG. 7 illustrates a reference image 200 divided into a first region 221 and a second region 222 by a perpendicular bisector 211. The image processing part 112 extracts a gravity center of a first feature object 231 in the first region 221 as a first feature point 2311, and extracts a gravity center of a second feature object 232 in the second region 222 as a second feature point 2321.

FIG. 7 illustrates a comparative image 201 captured at a later time than the reference image 200. The comparative image 202 is divided into a first region 221 and a second region 222 by a perpendicular bisector 211. The image processing part 112 extracts a gravity center of a third feature object 241 in the first region 221 as a third feature point 2411, and extracts a gravity center of a fourth feature object 242 in the second region 222 as a fourth feature point 2421.

In each first region 221, a boundary of a wall is recognized as each of the first feature object 231 and the third feature object 241. In each second region 222, a display arranged on the wall is recognized as each of the second feature object 232 and the fourth feature object 242. The first feature object 231 and the third feature object 241 indicate the same object. The second feature object 232 and the fourth feature object 242 indicate the same object. The comparative image 201 illustrated in FIG. 7 shows the first feature object 231 with a dashed outline and shows the second feature object 232 with a dashed outline.

When the photographing direction of the photographing device 30 is turned to agree with the rightward direction, a first change direction 251 from the first feature point 2311 to the third feature point 2411 and a second change direction 252 from the second feature point 2321 to the fourth feature point 2421 agree with the leftward direction.

It is noted here that each of the first change direction and the second change direction is not necessarily parallel to the horizontal direction or the X-direction, and that each of the first change direction and the second change direction may be at an angle to the horizontal direction or X-direction. Thus, the image processing part 112 may determine whether an X-component in the first change direction is greater than a Y-component in the first change direction, whether an X-component in the second change direction is greater than a Y-component in the second change direction, and whether both the X-component in the first change direction and the X-component in the second change direction face in the leftward direction (-X-direction).

Referring back to FIG. 5, when it is determined that both the first change direction and the second change direction agree with the leftward direction (YES in step S40), the process proceeds to step S44.

In contrast, when it is determined that both the first change direction and the second change direction do not agree with the leftward direction (NO in step S40), the image processing part 112 determines, in step S41, whether both the first change direction and the second change direction agree with the rightward direction.

When the photographing direction of the photographing device 30 is turned to agree with the leftward direction, the first change direction 251 from the first feature point 2311 to the third feature point 2411 and the second change direction 252 from the second feature point 2321 to the fourth feature point 2421 agree with the rightward direction.

It is noted here that each of the first change direction and the second change direction is not necessarily parallel to a horizontal direction or an X-direction, and that each of the first change direction and the second change direction may be at an angle to the horizontal direction or X-direction. Thus, the image processing part 112 may determine whether the X-component in the first change direction is greater than the Y-component in the first change direction, whether the X-component in the second change direction is greater than the Y-component in the second change direction, and whether both the X-component in the first change direction and the X-component in the second change direction face in the rightward direction (+X-direction).

When it is determined that both the first change direction and the second change direction agree with the right direction (YES in step S41), the process proceeds to step S44.

In contrast, when it is determined that both the first change direction and the second change direction do not agree with the rightward direction (NO in step S41), the image processing part 112 determines, in step S42, whether both the first change direction and the second change direction agree with the downward direction.

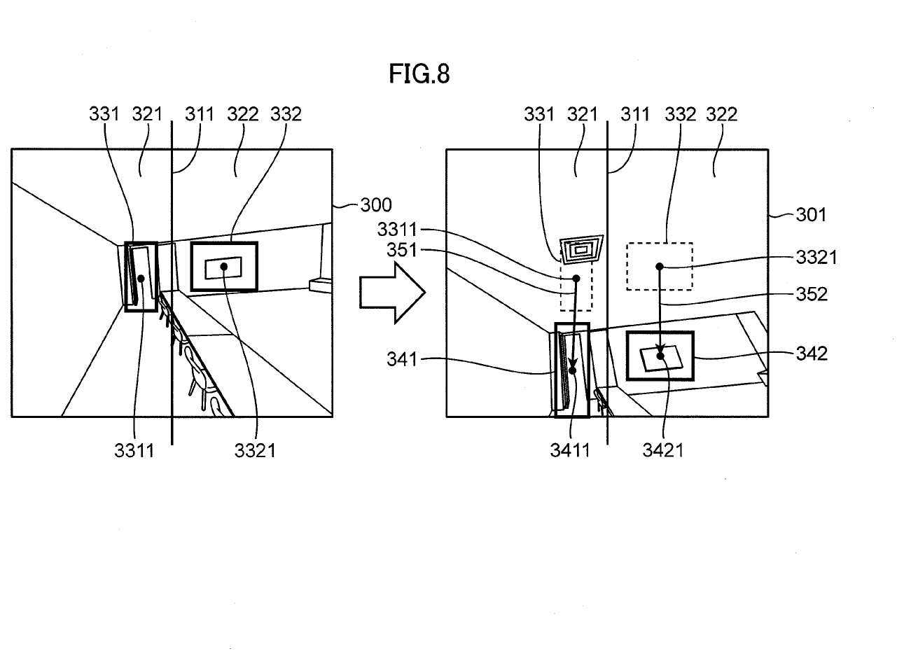

FIG. 8 illustrates an example reference image, and an example comparative image obtained by making the photographing direction of the photographing device 30 agree with the upward direction in the embodiment.

FIG. 8 illustrates a reference image 300 divided into a first region 321 and a second region 322 by a perpendicular bisector 311. The image processing part 112 extracts a gravity center of a first feature object 331 in the first region 321 as a first feature point 3311, and extracts a gravity center of a second feature object 332 in the second region 322 as a second feature point 3321.

FIG. 8 illustrates an comparative image 301 captured at a later time than the reference image 300. The comparative image 301 is divided into a first region 321 and a second region 322 by a perpendicular bisector 311. The image processing part 112 extracts a gravity center of a third feature object 341 in the first region 321 as a third feature point 3411, and extracts a gravity center of a fourth feature object 342 in the second region 322 as a fourth feature point 3421.

In each first region 321, a door is recognized as each of the first feature object 331 and the third feature object 341. In each second region 322, a display arranged on a wall is recognized as each of the second feature object 332 and the fourth feature object 342. The first feature object 331 and the third feature object 341 indicate the same object. The second feature object 332 and the fourth feature object 342 indicate the same object. The comparative image 301 illustrated in FIG. 8 shows the first feature object 331 with a dashed outline and shows the second feature object 332 with a dashed outline.

When the photographing direction of the photographing device 30 is made to agree with the upward direction, a first change direction 351 from the first feature point 3311 to the third feature point 3411 and a second change direction 352 from the second feature point 3321 to the fourth feature point 3421 agree with the downward direction.

It is noted here that each of the first change direction and the second change direction is not necessarily parallel to a vertical direction or Y-direction, and that each of the first change direction and the second change direction may be at an angle to the vertical direction or Y-direction. Thus, the image processing part 112 may determine whether a Y-component in the first change direction is greater than an X-component in the first change direction, whether a Y-component in the second change direction is greater than an X-component in the second change direction, and whether both the Y-component in the first change direction and the Y-component in the second change direction face in the downward direction (-Y-direction).

Although the image processing part 112 determines whether both the first change direction and the second change direction agree with the downward direction in the embodiment, the present disclosure is not particularly limited thereto. The image processing part 112 may determine only whether the first change direction agrees with the downward direction, or may determine only whether the second change direction agrees with the downward direction.

Referring back to FIG. 6, when it is determined that both the first change direction and the second change direction agree with the downward direction (YES in step S42), the process proceeds to step S45.

In contrast, when it is determined that both the first change direction and the second change direction do not agree with the downward direction (NO in step S42), the image processing part 112 determines, in step S43, whether both the first change direction and the second change direction agree with the upward direction.

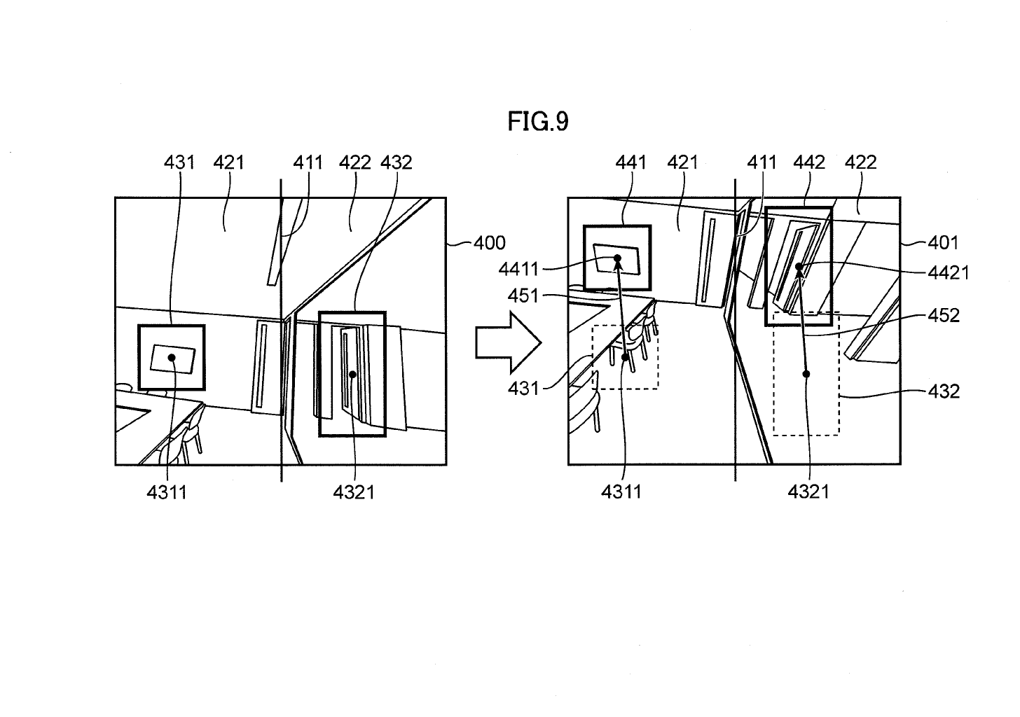

FIG. 9 illustrates an example reference image, and an example comparative image obtained by making the photographing direction of the photographing device 30 agree with the downward direction in the embodiment.

FIG. 9 illustrates a reference image 400 divided into a first region 421 and a second region 422 by a perpendicular bisector 411. The image processing part 112 extracts a gravity center of a first feature object 431 in the first region 421 as a first feature point 4311, and extracts a gravity center of a second feature object 432 in the second region 422 as a second feature point 4321.

FIG. 9 illustrates a comparative image 401 captured at a later time than the reference image 400. The comparative image 401 is divided into a first region 421 and a second region 422 by a perpendicular bisector 411. The image processing part 112 extracts a gravity center of a third feature object 441 in the first region 421 as a third feature point 4411, and extracts a gravity center of a fourth feature object 442 in the second region 422 as a fourth feature point 4421.

In each first region 421, a display arranged on a wall is recognized as each of the first feature object 431 and the third feature object 441. In each second region 422, a door is recognized as each of the second feature object 432 and the fourth feature object 442. The first feature object 431 and the third feature object 441 indicate the same object. The second feature object 432 and the fourth feature object 442 indicate the same object. The comparative image 401 illustrated in FIG. 9 shows the first feature object 431 with a dashed outline and shows the second feature object 432 with a dashed outline.

When the photographing direction of the photographing device 30 is made to agree with the downward direction, a first change direction 451 from the first feature point 4311 to the third feature point 4411 and a second change direction 452 from the second feature point 4321 to the fourth feature point 4421 agree with the upward direction.

It is noted here that each of the first change direction and the second change direction is not necessarily parallel to the vertical direction or the Y-direction, and that each of the first change direction and the second change direction may be at an angle to the vertical direction or Y-direction. Thus, the image processing part 112 may determine whether the Y-component in the first change direction is greater than the X-component in the first change direction, whether the Y-component in the second change direction is greater than the X-component in the second change direction, and whether both the Y-component in the first change direction and the Y-component in the second change direction face in the upward direction (+Y-direction) .

Although the image processing part 112 determines whether both the first change direction and the second change direction agree with the upward direction in the embodiment, the present disclosure is not particularly limited thereto. The image processing part 112 may determine only whether the first change direction agrees with the upward direction, or may determine only whether the second change direction agrees with the upward direction.

Referring back to FIG. 6, when it is determined that both the first change direction and the second change direction agree with the upward direction (YES in step S43), the process proceeds to step S45.

In contrast, when it is determined that both the first change direction and the second change direction do not agree with the upward direction, that is, when the first change direction agrees with the leftward direction and the second change direction agrees with the rightward direction, (NO in step S43), the image processing part 112 determines, in step S44, whether at least one of the first change amount and the second change amount has the threshold or higher.

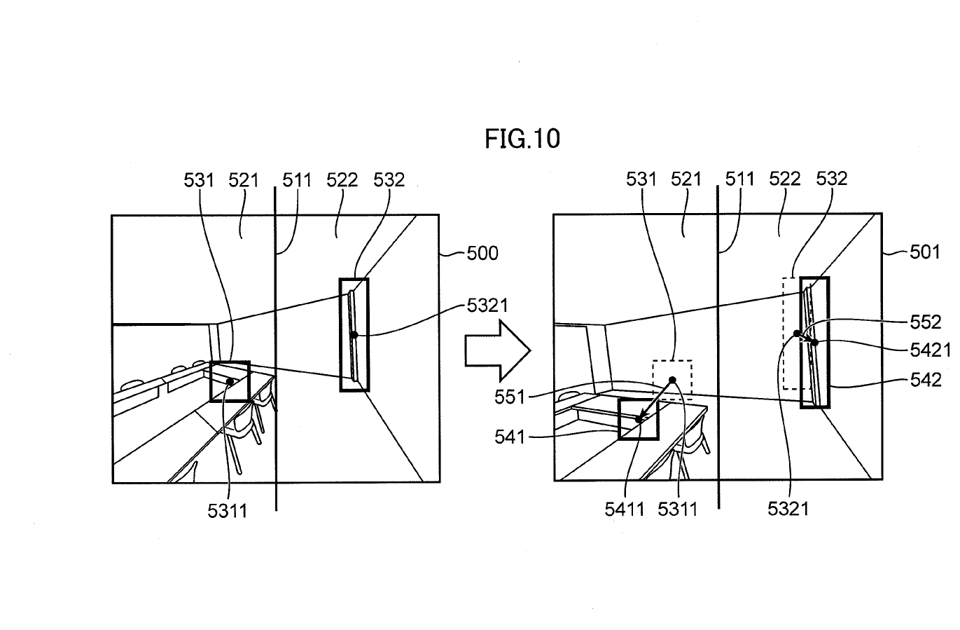

FIG. 10 illustrates an example reference image, and an example comparative image obtained in advancement of the photographing device 30 in the photographing direction.

FIG. 10 illustrates a reference image 500 divided into a first region 521 and a second region 522 by a perpendicular bisector 511. The image processing part 112 extracts a gravity center of a first feature object 531 in the first region 521 as a first feature point 5311, and extracts a gravity center of a second feature object 532 in the second region 522 as a second feature point 5321.

FIG. 10 illustrates a comparative image 501 captured at a later time than the reference image 500. The comparative image 501 is divided into a first region 521 and a second region 522 by a perpendicular bisector 511. The image processing part 112 extracts a gravity center of a third feature object 541 in the first region 521 as a third feature point 5411, and extracts a gravity center of a fourth feature object 542 in the second region 522 as a fourth feature point 5421.

In each first region 521, an inner corner of a table is recognized as each of the first feature object 531 and the third feature object 541. In each second region 522, a pillar is recognized as each of the second feature object 532 and the fourth feature object 542. The first feature object 531 and the third feature object 541 indicate the same object. The second feature object 532 and the fourth feature object 542 indicate the same object. The comparative image 501 illustrated in FIG. 10 shows the first feature object 531 with a dashed outline and shows the second feature object 532 with a dashed outline.

When the photographing device 30 advances in the photographing direction, a first change direction 551 from the first feature point 5311 to the third feature point 5411 agrees with the leftward direction, and a second change direction 552 from the second feature point 5321 to the fourth feature point 5421 agrees with the rightward direction. More accurately, when the photographing device 30 advances in the photographing direction, the first change direction 551 from the first feature point 5311 to the third feature point 5411 agrees with a downward and leftward direction, and the second change direction 552 from the second feature point 5321 to the fourth feature point 5421 agrees with a downward and rightward direction.

When it is determined that both the first change direction and the second change direction do not agree with the upward direction in step S43, the image processing part 112 may determine whether the X-component in the first change direction faces in the leftward direction (-X-direction) and the X-component in the second change direction faces in the rightward direction (+X-direction).

Referring back to FIG. 6, when it is determined that each of the first change amount and the second change amount does not have the threshold or higher, that is, when it is determined that both the first change amount and the second change amount have a value lower than the threshold (NO in step S44), the image processing part 112 deletes, in step S45, the comparative image. The process then returns to step S36, and the image processing part 112 acquires, as a new comparative image, an image at a subsequent frame to the deleted comparative image.

In contrast, when it is determined that at least one of the first change amount and the second change amount has the threshold or higher (YES in step S44), the image processing part 112 causes the image information storage part 122 of the memory 12 to store the comparative image in step S46. At this time, the image processing part 112 causes the image information storage part 122 to store image information including the reference image and the comparative image. The image information associates a plurality of images captured by the photographing device 30 and subjected to the reduction and meta information about each of the images with each other. The meta information includes a photographing ID, a photographing date and time, a photographing direction, a photographing spot, and a design drawing ID.

Subsequently, in step S47, the image processing part 112 determines whether all the images included in the initial image information generated by the acquisition part 111 are acquired as comparative images.

When it is determined that not all of the images are acquired as comparative images (NO in step S47), the process returns to step S34, and the image processing part 112 acquires, as a new reference image, a comparative image having been stored.

In contrast, when it is determined that all the images are acquired as comparative images (YES in step S47), the process is finished.

Next, an image displaying process by the server 10 in the embodiment will be described.

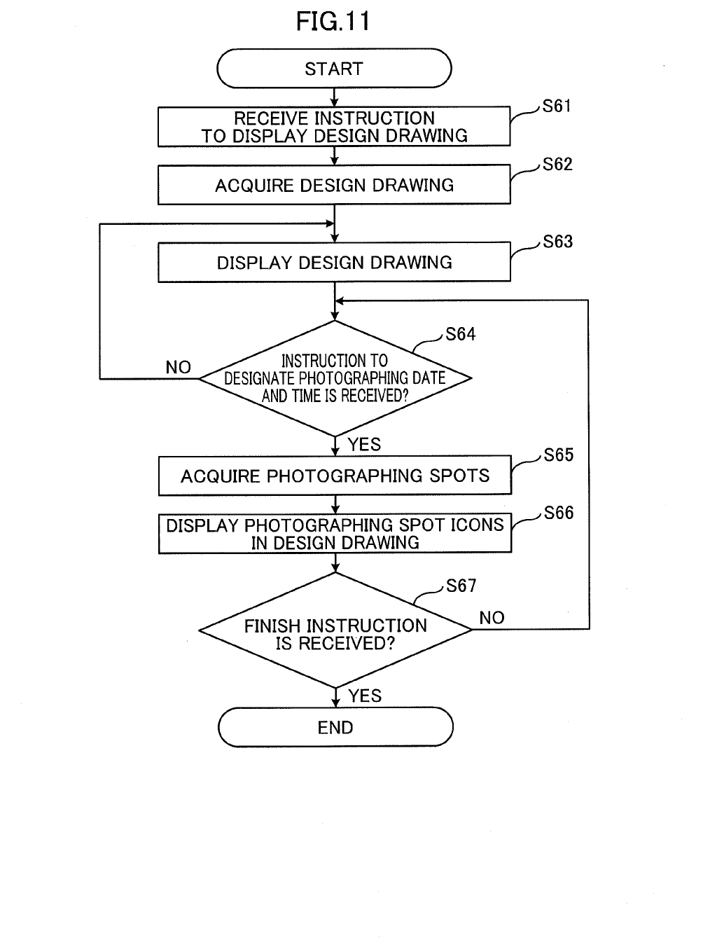

FIG. 11 is a flowchart showing an example of the image displaying process by the server 10 in the embodiment.

First, in step S61, the communication part 13 receives, from the information terminal 20, an instruction to display a design drawing. In this case, the display 23 of the information terminal 20 displays a menu screen image for design drawing selection, and the manipulation part 24 receives an instruction from the user to select one design drawing from the menu screen image. The instruction input in this manner is sent to the server 10 via the network NT and received by the communication part 13. The instruction to display the design drawing contains a design drawing ID.

Subsequently, in step S62, the acquisition part 111 acquires, from design drawing information stored in the design drawing information storage part 121, a design drawing corresponding to the design drawing ID contained in the instruction to display the design drawing received by the communication part 13.

Then, in step S63, the display control part 113 sends display data for the design drawing to the information terminal 20 via the communication part 13, and then causes the display 23 of the information terminal 20 to display the design drawing. A display screen image displayed as a default shows the design drawing selected in step S61 and a selection receipt field to select a photographing date and time. The selection receipt field shows photographing dates and times being available for displaying and thus displayed in a selectable manner, and the manipulation part 24 receives an instruction from the user to select a desired photographing date and time in the selection receipt field. Each photographing date and time shown in the selection receipt field indicates a representative value of a photographing date and time included in the image information stored in the memory 12. Examples of the representative value include a photographing start date and time. Selection of the photographing date and time leads to selection of one photographing operation corresponding to the photographing date and time. The instruction to designate the photographing date and time is sent to the server 10 via the network NT and received by the communication part 13. The instruction to designate the photographing date and time contains a photographing ID.

Next, in step S64, the acquisition part 111 determines whether the communication part 13 receives an instruction to designate a photographing date and time. When it is determined that the communication part 13 receives no instruction to designate a photographing date and time (NO in step S64), the process returns to step S63.

In contrast, when it is determined that the communication part 13 receives an instruction to designate a photographing date and time (YES in step S64), the acquisition part 111 acquires, from the image information stored in the image information storage part 122, a plurality of photographing spots each corresponding to the photographing ID contained in the instruction to designate the photographing date and time received by the communication part 13, in step S65.

Subsequently, in step S66, the display control part 113 sends, to the information terminal 20 via the communication part 13, a display instruction to display, in the design drawing, a plurality of photographing spot icons respectively indicating the photographing spots, and then displays, in the design drawing being displayed on the display 23 of the information terminal 20, the photographing spot icons respectively indicating the photographing spots. At this time, the display control part 113 is configured to display, in the design drawing, a first photographing spot icon associated with a first image and a second photographing spot icon associated with a second image, the second image showing that a change amount from the first image to the second image has a threshold or higher. For instance, the display control part 113 causes the display 23 to display the design drawing screen image 100A illustrated in FIG. 3.

Then, in step S67, the acquisition part 111 determines whether the communication part 13 receives a finish instruction. The finish instruction is an instruction to close the design drawing displayed in the step S63. The instruction is input in response to a manipulation to press a finish button (not shown) displayed on the display 23. When it is determined that the communication part 13 receives a finish instruction (YES in step S67), the process is finished. In contrast, when it is determined that the communication part 13 receives no finish instruction (NO in step S67), the process returns to step S64. In this case, the displaying of the design drawing is maintained. The finish instruction is sent to the server 10 via the network NT and received by the communication part 13. The acquisition part 111 acquires the finish instruction via the communication part 13.

This configuration causes the memory 12 to store the first image and the second image showing that the change amount has the threshold or higher, and thus enables deletion of an image located between the first image and the second image and achieves a reduction in an image data amount.

The reduction in the image data amount in the server 10 leads to achievement in a reduction in an amount of data stored in the memory 12 of the server 10, and further leads to achievement in saving of time for sending the data to the information terminal 20.

The communication device 40 may include the image processing part 112. In this configuration, a reduction in an image data amount in the communication device 40 leads to achievement in a reduction in a data amount to be sent to the server 10, and further leads to achievement in saving of time for sending the data to the server 10.

The technology according to the present disclosure achieves a reduction in an image data amount, and thus is useful as a technology to display an image.

1. An information processing method to be executed by a computer, comprising: displaying a bird’s-eye view on a display of an information terminal; and displaying, in the bird’s-eye view, a plurality of photographing spot icons respectively indicating a plurality of photographing spots, wherein the photographing spot icons are respectively associated with a plurality of images captured at the photographing spots, the images include a first image and a second image captured at a later time than the first image, and the displaying of the photographing spot icons includes displaying, in the bird’s-eye view, a first photographing spot icon associated with the first image and a second photographing spot icon associated with the second image, the second image showing a change amount from the first image that has a predetermined value or higher.

2. The information processing method according to claim 1, wherein the displaying of the photographing spot icons includes displaying, in the bird’s-eye view, the first photographing spot icon associated with the first image and the second photographing spot icon associated with the second image, the second image showing that the change amount from the first image to the second image has a threshold or higher.

3. The information processing method according to claim 2, further comprising: acquiring a reference image from among the images; acquiring a comparative image captured at a later time than the reference image from among the images; extracting a first feature point and a second feature point respectively from a first region and a second region resulting from horizontally dividing the reference image; extracting a third feature point and a fourth feature point respectively from a first region and a second region resulting from horizontally dividing the comparative image; calculating a first change amount from a position of the first feature point to a position of the third feature point; calculating a second change amount from a position of the second feature point to a position of the fourth feature point; and displaying the comparative image as the second image when at least one of the first change amount and the second change amount has the threshold or higher.

4. The information processing method according to claim 3, further comprising avoiding displaying the comparative image when each of the first change amount and the second change amount does not have the threshold or higher.

5. The information processing method according to claim 3, wherein the acquiring of the reference image includes firstly acquiring, as the reference image, an image captured at a photographing start spot, and acquiring, when the comparative image remains as the second image, the remaining comparative image as the reference image.

6. The information processing method according to claim 3, further comprising: calculating a first change direction from the position of the first feature point to the position of the third feature point; calculating a second change direction from the position of the second feature point to the position of the fourth feature point; and determining whether at least one of the first change amount and the second change amount has the threshold or higher when the first change direction and the second change direction agree with a leftward direction or the first change direction and the second change direction agree with a rightward direction.

7. The information processing method according to claim 6, further comprising deleting the comparative image when the first change direction and the second change direction agree with an upward direction or the first change direction and the second change direction agree with a downward direction.

8. The information processing method according to claim 6, further comprising determining whether at least one of the first change amount and the second change amount has the threshold or higher when one of the first change direction and the second change direction agrees with the leftward direction and the other of the first change direction and the second change direction agrees with the rightward direction.

9. The information processing method according to claim 6, wherein the extracting of the first feature point and the second feature point includes recognizing a first feature object from the first region included in the reference image and extracting a gravity center of the recognized first feature object as the first feature point, and recognizing a second feature object from the second region included in the reference image and extracting a gravity center of the recognized second feature object as the second feature point, and the extracting of the third feature point and the fourth feature point includes recognizing a third feature object from the first region included in the comparative image and extracting a gravity center of the recognized third feature object as the third feature point, and recognizing a fourth feature object from the second region included in the comparative image and extracting a gravity center of the recognized fourth feature object as the fourth feature point.

10. An information processing device, comprising: a processor, the processor being configured to: display a bird’s-eye view on a display of an information terminal; and display, in the bird’s-eye view, a plurality of photographing spot icons respectively indicating a plurality of photographing spots, wherein the photographing spot icons are respectively associated with a plurality of images captured at the photographing spots, the images include a first image and a second image captured at a later time than the first image, and, in the displaying of the photographing spot icons, a first photographing spot icon associated with the first image and a second photographing spot icon associated with the second image are displayed in the bird’s-eye view, the second image showing a change amount from the first image that has a predetermined value or higher.

11. A non-transitory computer readable recording medium storing an information processing program, comprising causing a computer to: display a bird’s-eye view on a display of an information terminal; and display, in the bird’s-eye view, a plurality of photographing spot icons respectively indicating a plurality of photographing spots, wherein the photographing spot icons are respectively associated with a plurality of images captured at the photographing spots, the images include a first image and a second image captured at a later time than the first image, and, in the displaying of the photographing spot icons, a first photographing spot icon associated with the first image and a second photographing spot icon associated with the second image are displayed in the bird’s-eye view, the second image showing a change amount from the first image that has a predetermined value or higher.
